(19) United States
(12) Patent Application Publication
(10) Pub. No.: US 2018/0178550 A1
(43) Pub. Date: Jun. 28, 2018

(54) METHOD OF PRODUCING A PRINT PRODUCT

(71) Applicant: Océ Holding B.V., Venlo (NL)

(72) Inventors: Martinus A. KREMERS, Venlo (NL); Christophe A. LEYNADIER, Maisons Alfort (FR); Maria V. ORTIZ-SEGOVIA, Paris (FR); Bianca P.S. SLAATS, Venlo (NL)

(73) Assignee: Océ Holding B.V., Venlo (NL)

(21) Appl. No.: 15/851,017

(22) Filed: Dec. 21, 2017

(30) Foreign Application Priority Data
Dec. 22, 2016 (EP) 16206267.3

(51) Int. Cl. B41J 3/407; D06P 5/30; B41J 11/00

(52) U.S. Cl. CPC B41J 3/4078; B41J 2/01; B41J 11/002; D06P 5/30

(57) ABSTRACT

A method of producing a print product by controlling a printing element to form ink dots on a textured surface of a substrate includes capturing an image of the textured surface with an opto-electronic device; processing data received from the opto-electronic device, thereby to locate surface areas of the textured surface that are suitable for receiving ink; and controlling the printing element to form ink dots selectively on the located surface areas. The ink dots that are expected not to reach the surface of the substrate are not applied. The method better preserves the texture of the textured substrate surface and avoids the unnecessary application of ink.

### BACKGROUND OF THE INVENTION

### 1. Field of the Invention

The invention relates to a method of producing a print product by controlling a printing element to form ink dots on a textured surface of a substrate, comprising texture elements.

### 2. Description of the Related Art

A conventional print product typically has a sheet-like, flat substrate with an image or pattern printed on its surface. The image or pattern is composed of ink dots which have been applied by means of one or more printing elements of a print head, e.g. an ink jet print head.

A textured surface of a substrate is a substrate surface that has a texture, i.e. a surface that is composed of a plurality of surface areas, texture elements, which vary in distance to an imaginary plane parallel to the substrate. As a result, a print element of a print head moving in a plane parallel to the substrate has a varying distance to the different surface areas. For example, a substrate which takes the form of a textile cloth can be considered as a substrate having a textured surface. In that case the surface is composed of surface areas where yarn threads are present and other surface areas which are constituted by voids between the yarn threads or are constituted by yarn threads that are located in a lower layer of the textile.

It is generally known to produce printed products by printing upon textile substrates. The printed image or pattern will typically be applied to cover the entire surface of the substrate and will thus at least partly obscure the texture of the substrate. In some cases, the applied ink will not get into contact with the substrate and thus pollutes an ink application part of the production device.

It is known to arrange a print process in order to avoid substrate faults, such as described in patent application US2013/0239833 A1. Also known is a method of printing on an unbacked fabric, using a fabric characterization and tension control subsystem, including an irregularity detection subsystem, such as described in patent application EP 1457347 A1. However, these disclosures are not discussing a print process that is sensitive to the texture of the substrate itself.

It is an object of the invention to provide a new type of print products in which a texture of a textured substrate surface is better preserved. It is a further object of the invention to avoid spoiling ink and polluting an ink application area.

### SUMMARY OF THE INVENTION

In order to achieve this object, the method according to the invention comprises the steps of:
capturing an image of the textured surface with an opto-electronic device;
processing data received from the opto-electronic device, thereby locating surfaces areas of the textured surface that are suitable for receiving ink; and
controlling the printing element to form ink dots selectively on the surfaces areas, wherein ink dots that are expected not to reach the top of the texture elements on the surface of the substrate are not applied.

On the substrate, surfaces areas of the textured surface are distinguishable from other surface areas. In the example mentioned above, surfaces areas that are suitable for receiving ink are the positions where yarns are present on the surface of the substrate, the pre-defined feature being the presence of a yarn thread in a top layer of the substrate. The voids between the yarn threads are in that case the surface areas that do not have this feature. By printing selectively on surface areas that have the pre-defined feature, the invention permits to match the printed pattern to the texture of the substrate, so that the perceptibility of the texture is preserved or even enhanced. Furthermore, the application of print material in the form of ink dots is fitted to the parts of the surface area having this pre-defined feature and unnecessary use of ink is avoided.

More specific optional features of the invention are indicated in the dependent claims.

In one embodiment, the substrate is formed by a textile material, and the textured surface of the substrate comprises surface areas which have the feature that yarn threads of the textile material are exposed at the surface. Then, the printing element, or preferably a plurality of such printing elements, may be controlled to print selectively onto the yarn threads. In this way it is possible to obtain a print product in which the appearance of the textured surface is improved by a printed image or pattern applied thereon, but pores or voids between the yarn threads are not covered with ink and therefore remain open. This helps to preserve certain desired properties of the textile, such as permeability for gases and liquids, elasticity or drapability and “grip” or “hand” of the textile cloth. Thereby, no ink is wasted by application of ink dots in the pores.

The ink applied to the substrate may be an aqueous textile ink. This ink is suitable for permeating textile fibres and coloring them thoroughly.

In another embodiment, the ink applied to the substrate may be an electrically conductive ink, preferably an ink which remains flexible, so that the textile substrate is converted to a flexible conductor without substantially changing other physical properties of the substrate and/or its appearance.

On the other hand, the ink applied to the substrate surface may be utilized for locally stiffening the yarn threads. For example, a UV-curing ink may be suitable for that purpose.

Optionally, the pre-defined feature may be defined such that it requires not just the presence of any yarn at the surface of the substrate but the presence of specific yarn threads, e.g. yarns of a specific material or weft threads only or warp threads only in case of a woven fabric. In the latter case an anisotropic stiffness of the print product may be achieved.

In case that the textile substrate has relatively large pores or holes, the invention has also the advantage that it is avoided that ink is wasted and/or stains a print surface that supports the substrate.

In a further embodiment, ink is applied on a specific side of the texture on the substrate. This is achieved by locating the texture elements and applying ink on one side of these elements only. If this is done for two different sides of the texture elements, a directional effect of seeing different images in different directions is obtained.

In a further embodiment, the textured substrate is viewed by the opto-electronic device under different angles, or two opto-electronic devices are used, in order to make an estimate of the height of the textured elements. Knowing this height improves the accuracy for applying ink dots.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

Embodiment examples will now be described in conjunction with the drawings, wherein:

FIG. 1 is a schematic perspective view of a printer arranged for carrying out the method according to the invention;

FIG. 2 is a top plan view of a textile substrate onto which ink has been applied by the method according to the invention;

FIG. 3 is an enlarged sectional view of the substrate, taken along the line III-III in FIG. 2, and showing also a printing element with which ink dots are applied on the substrate;

FIG. 4 is a sectional view similar to the one in FIG. 3 but showing a print product obtained in accordance with a modified embodiment of the invention; and

FIG. 5 is a flow diagram illustrating essential steps of the method according to the invention.

### DETAILED DESCRIPTION OF EMBODIMENTS

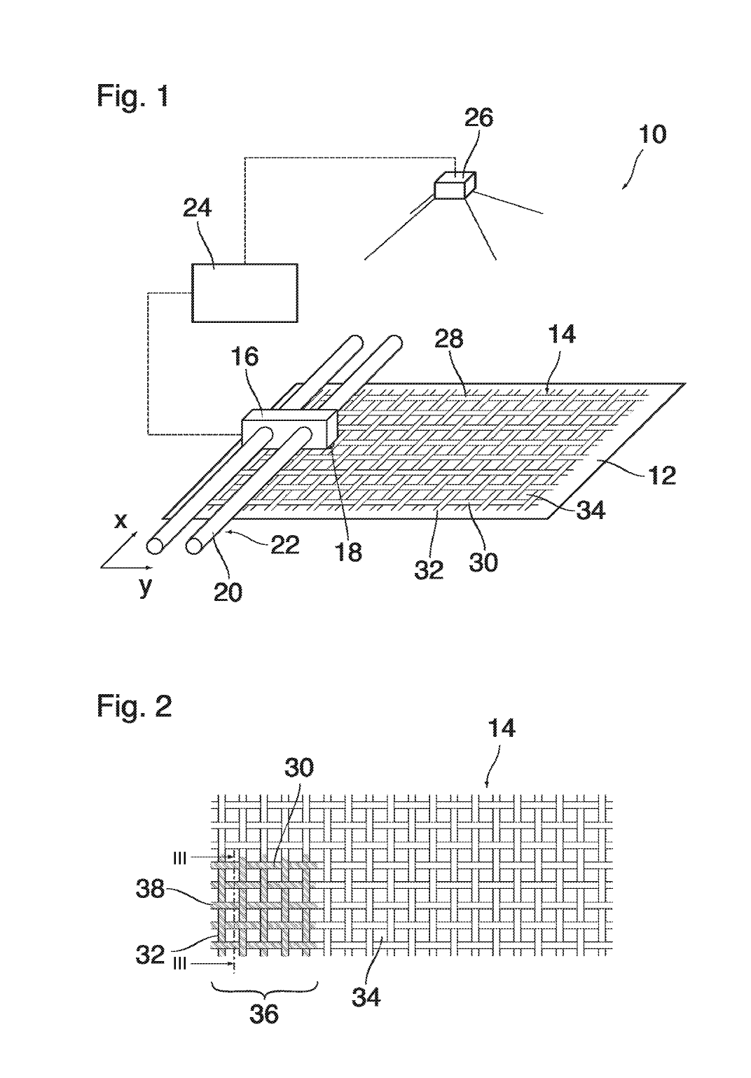

As is shown in FIG. 1, a printer 10, e.g. an ink jet printer, has a print surface 12 supporting a substrate 14, and an ink jet print head 16 arranged to scan the surface of the substrate 14.

The print head 16 has a plurality of printing elements 18 arranged in a row, or, alternatively, in multiple rows, on a side facing the surface of the substrate 14. The printing elements 18 are capable of ejecting ink droplets so as to form ink dots on the surface of the substrate. The print head 16 is movable in a main scanning direction x along guide rails 20, so that a swath of an image can be printed onto the substrate 14 in each pass of the print head. The guide rails 20 form part of a gantry 22 which is movable relative to the print surface 12 in a sub-scanning direction y normal to the main scanning direction x, so that, when a swath of the image has been printed, the print head can be moved by one step in the sub-scanning direction y in order to print an adjacent swath in the next pass. Alternatively (not shown in the figure), the print head may be placed on a carriage comprising several print heads.

The movements of the print head 16 and the gantry 22 as well as the operations of the printing elements 18 are controlled by an electronic controller 24.

A camera 26 (opto-electronic device) is disposed above the print surface 12 so as to capture an image of the substrate 14. The camera 26 is connected to the controller 24 where the image data can be processed. In an alternative arrangement, the camera 26 may be mounted on a carriage in addition to one or more print heads. In that case, a scanning movement of the carriage enables the capture of an image of the substrate 14.

In this example, the substrate 14 is constituted by a textile cloth, more specifically a woven fabric in this example, and therefore has a textured surface 28 which is to receive the image printed with the print head 16.

Before a print process starts, the gantry 22 is moved away from the print surface 12 so that the camera 26 can capture an image of the entire surface of the substrate 14. If the camera is mounted on a carriage, or if the substrate is too large to be captured completely, it may be sufficient to capture a part of the surface of the substrate.

The textured surface 28 of the substrate has surface areas 30, 32 of a first type which is defined by the feature that these surface areas are constituted by weft threads and warp threads exposed at the surface of the substrate. In this example, the fabric forming the substrate 14 has relatively large pores or holes between the weft and warp threads. These holes constitute surface areas 34 of a second type which does not have the feature that defines the surface areas 30, 32 of the first type.

Image processing software implemented in the controller 24 analyses the image data obtained from the camera 26 and identifies the locations of the surface areas 30, 32 of the first type. Further, as is generally known in the art, the controller 24 receives or creates bitmap data that define the image to be printed in terms of a pattern of ink dots to be formed on the substrate. In the present embodiment, these bitmap data are masked with the locations of the surface areas 30, 32 of the first type, so that ink dots will only be formed in these surface areas but not in the surface areas 34 of the second type.

The result is shown in FIG. 2 where the print head 16 has printed a part of a swath 36 of the image onto the substrate 14. The areas where ink dots have been applied in accordance with the bitmap data have been shown as hatched areas 38 in FIG. 2. It can be seen that ink dots have been applied only in the surface areas 30 and 32, i.e. on the weft and warp threads of the fabric, but not in the areas 34, which correspond to the holes in the fabric.

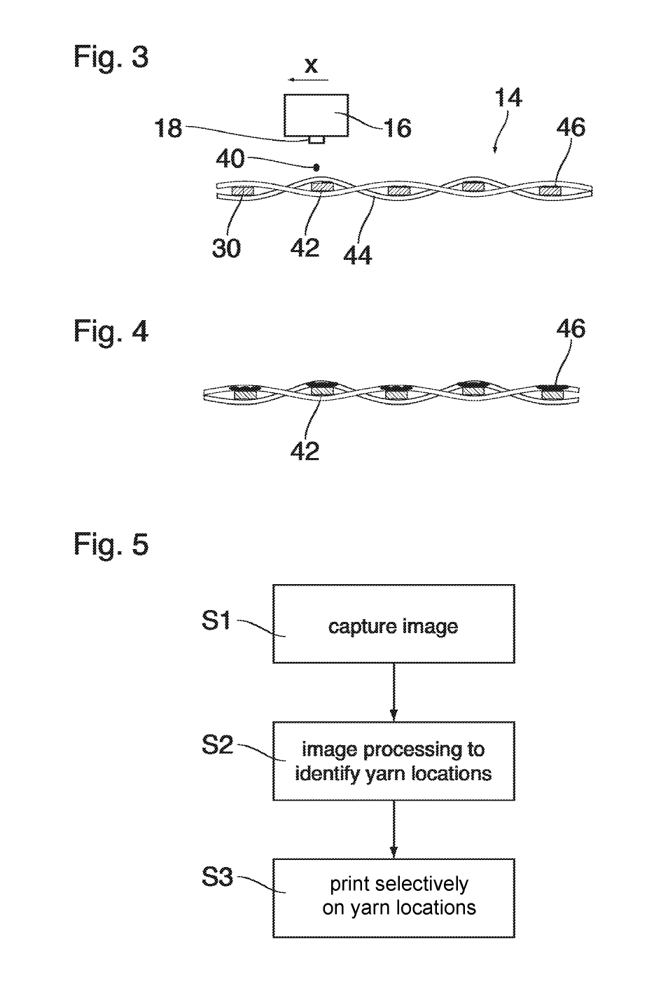

FIG. 3 shows the same result as FIG. 2 in a sectional view and shows also an individual printing element 18 of the print head 16 which moves in the main scanning direction x. The printing element 18 has just jetted an ink droplet 40 onto the textured surface of the substrate 14.

As is shown in FIG. 3, the fabric forming the substrate 14 has warp threads 42 and weft threads 44. The printing element 18 has formed ink dots 46 on the surface areas 30 which are constituted by the top surfaces of the warp threads 42.

In the example shown in FIG. 2, ink dots will also be deposited on the top surfaces of the weft threads 44, at least in those portions where these weft threads are exposed on the top side of the substrate.

In a modified embodiment, however, it would also be possible that ink dots are applied only to the warp threads 42 but not to the weft threads 44 or vice versa.

In the example shown in FIG. 3, only a single layer of ink is applied to the warp threads. FIG. 4 shows a modified embodiment where several layers of ink are applied to the warp threads 42. In this case, the ink dots 46 in the top layer may be offset from the dots in the lower layer so that they gradually overlay the holes between the threads. It is also possible to perform relief printing by adding more and more ink layers on the surface areas 30, 32 of the first type. Eventually, the holes between the warp and weft threads may be closed completely on the top side of the substrate. Still, the texture would be preserved on the bottom side of the substrate where the holes between the warp and weft threads would take the form of deep cavities.

FIG. 5 illustrates the essential steps of the method according to the invention.

In step S1 the camera 26 captures an image of the textured surface 28 of the substrate. In step S2 the image data are processed in the controller 24 in order to identify the locations where the surface of the substrate is formed by yarn threads, i.e. the locations of the surface areas 30, 32 of the first type.

Then, the substrate 14 is scanned with the print head 16 in step S3 and ink dots 46 will be formed only on the surface areas 30, 32 where the yarn is present.

The step S2 may be performed before the print head 16 starts printing. It is possible however that image processing is at first limited to the swath to be printed first and image processing for the subsequent swathes is performed only when the print head has started printing already.

In cases where the surface areas 30, 32 of the first type, i.e. the areas where ink shall be applied, are easy to identify, e.g. by their color, so that the step S2 requires only little processing time, it may even be possible to replace the camera 26 by a camera that is mounted on a print head carriage and scans the substrate 14 together with the print head.

Optionally, the camera 26 may be a 3D-camera capable of distinguishing treads at the surface of the textile from threads deeper in the textile.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method of producing a print product by controlling a printing element to form ink dots on a textured surface of a substrate, comprising texture elements, said method comprising the steps of:
capturing an image of the textured surface with an opto-electronic device;
processing data received from the opto-electronic device, thereby locating surface areas of the textured surface that are suitable for receiving ink;
controlling the printing element to form ink dots selectively on the located surface areas,
preventing application of ink dots that are not expected to reach the top of the texture elements on the surface of the substrate.

2. The method according to claim 1, wherein the textured surface of the substrate is formed by a textile material and the pre-defined feature is constituted by yarn threads exposed at the surface of the substrate.

3. The method according to claim 2, wherein the textile material comprises yarn threads of different types, and the pre-defined feature further specifies that the surface area is constituted by yarn threads of a specific type.

4. The method according to claim 1, wherein the printing element is an ink jet printing element.

5. The method according to claim 1, wherein the ink dots are dots of an aqueous textile ink.

6. The method according to claim 1, wherein the ink dots are dots of a UV-curable ink.

7. The method according to claim 1, wherein the ink dots are dots of an electrically conductive ink.

8. The method according to claim 1, wherein a textured surface is captured from two angles in order to estimate a height of the texture elements on the surface.

9. The method according to claim 1, wherein the located surface areas are one of the two sides of a texture element and ink is applied on a single side of this element only.

10. The method according to claim 1, wherein the opto-electronic device is a camera.

11. A printer for carrying out the method according to claim 1, the printer comprising:
a print surface for supporting a substrate;
at least one printing element;
an electronic controller; and
an opto-electronic device provided for capturing an image of a surface of the substrate on the print surface,
wherein the controller is configured:
to process data received from the opto-electronic device, thereby to locate surface areas of the surface of the substrate, that are suitable for receiving ink;
to control the at least one printing element to form ink dots selectively on the located surface areas; and
to prevent application of ink dots that are not expected to reach the top of the texture elements on the surface of the substrate.

12. The method according to claim 3, wherein the yarn threads of different types are warp threads or weft threads.
